(19) United States
(12) Patent Application Publication
(10) Pub. No.: US 2004/0168051 A1
(43) Pub. Date: Aug. 26, 2004

(54) Optimally provisioning connectivity for network-based mobile virtual private network (VPN) services

(75) Inventors: Katherine H. Guo, Eatontown, NJ (US); Li Li, Iselin, NJ (US); Sarit Mukherjee, Morganville, NJ (US); Sanjoy Paul, Marlboro, NJ (US); Sampath Rangarajan, Bridgewater, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: LUCENT TECHNOLOGIES INC.

(21) Appl. No.: 10/374,940

(22) Filed: Feb. 26, 2003

(51) Int. Cl. H04L 9/32

(52) U.S. Cl. 713/153

(57) ABSTRACT

A method and apparatus for optimally provisioning connectivity for network-based mobile virtual private network (VPN) services. The method and apparatus includes provisioning each of a plurality of IP service gateways (IPSGs) to support virtual private network (VPN) tunneling between customer premise equipment of a subset of VPN customers and at least one mobile access point (MAP). Each MAP is geographically remote from the plurality of IPSGs, and supports VPN tunneling to mobile nodes of the subset of VPN customers.

### FIELD OF INVENTION

The present invention relates to virtual private network (VPN) services. More specifically, the present invention relates to a service for providing connectivity for mobile devises utilizing VPN services.

### DESCRIPTION OF THE BACKGROUND ART

A Virtual Private Network (VPN) is a cost effective and secure way of extending enterprise network resources over a shared public data network. Most popular uses of VPNs are to interconnect multiple geographically dispersed sites of an enterprise (known as intranet/extranet VPN) and to provide remote users access to the enterprise resources (known as remote access VPN). In particular, a virtual private network (VPN) is an overlay network that uses the public network to carry data traffic between corporate sites and users, maintaining privacy through the use of tunneling protocols and security procedures.

In the network-based VPN model, an intranet/extranet VPN is created by interconnecting Customer Premise Equipments (CPE) of the enterprise to one or more VPN-aware network elements provisioned for the enterprise customer. A remote access VPN is created by tunneling the remote user's connection to a VPN-aware network element provisioned for the enterprise customer that the user belongs to. The VPN-aware network element then tunnels the connection to the appropriate CPE using tunnel concatenation. One such VPN-aware network element is a service switch called the IP Services Gateway (IPSG). An IPSG can be provisioned to serve a number of enterprise VPN customers each with a number of end users.

The basic method of setting up a VPN from a user or a site to secure enterprise resources is to set up a secure data connection between them over the underlying insecure shared network. An IPSG usually sets up two secure tunnels, one from the user/site to the IPSG itself, and the other from the IPSG to the enterprise. The IPSG is also responsible for maintaining separate and independent security associations with both ends, namely the user/site and the enterprise. The data flows end-to-end through the concatenated tunnel via the IPSG. Note that in a network-based VPN model, the network does not simply act as a conduit, but enables the VPN service. Moreover, the IPSG can enable other value-added services from the tunnel concatenation points. Examples include better QoS guarantees for VPN tunnels, service differentiation among users, offloading of Internet traffic from the enterprise intranet, and the like.

The IPSG provisioning process creates virtual instances of routing mechanisms for each of the customers facilitated in the IPSG. In one possible implementation, each instance may be a separate (virtual) router running customer specific routing algorithms. In other implementations, each instance could be distinct customer specific route entries in the partitioned routing table. As such, each routing instance requires a considerable amount of computing resources. Further, since all the instances share the common resources of the IPSG, the number of VPN customers that can be provisioned on an IPSG is limited. There is a similar restriction on the number of tunnels an IPSG can support. Moreover, due to physical resource constraints, configuring an IPSG with increased number of provisions reduces the number of tunnels that can be handled, and vice versa. IPSG provisioning per customer is usually carried out statically because of the complexity of the process and IPSG provisioning is not changed frequently.

At present, remote access VPNs are mostly limited to end users connecting to the enterprise from remote locations using wireline access like dial-up, DSL, and Cable-Modem lines. With the emergence of high-speed wireless data services in 2.5G and 3G wireless technologies, VPN usage from mobile nodes (that is, mobile VPN services) is growing exponentially.

In order to enable mobile data services, a network service provider (NSP) installs wireless access devices at the edge of its network. Radio-to-packet network gateways (i.e., Mobile Access Points (MAPs)) connect the access devices to the data network. To set up a data session, a mobile end user (hereinafter termed a “mobile node” (MN)) must first connect to a MAP, which then routes the session towards the destination CPE through an appropriately provisioned IPSG. A mobile data session originating from a MN to a MAP, and then routed through an IPSG to the enterprise CPE, is the basis of a network-based mobile VPN service. Currently, the IPSG and MAP are collocated in the network, where an IPSG/MAP performs radio to packet network gateway functions to terminate the MN's connection, as well as conducting other IPSG specific functions.

FIG. 1 depicts a high-level block diagram of a prior art mobile IP network 100. In such a scenario the MN is not free to choose an IPSG, rather its data sessions are anchored to the IPSG serving the MN's current roaming region. Note that the VPN service can be initiated only after the MN has started the data session.

The exemplary network 100 comprises a backbone network 102, such as the Internet, a plurality of enterprise networks 120₁ through 120ᵣ (collectively enterprise networks 120), and a network service provider (NSP) 101. The enterprise networks 120 each include at least one customer premise equipment (CPE) 122 and a plurality of mobile nodes (MN) 130₁ through 130ₘ collectively MNs 130). In this example, there are three VPN customers A, B and C, each with a corresponding intranet site 120. Customer A has two CPEs 122₁₁ and 122₁₂, while customers B and C each have one CPE 122₂₁ and 122ᵣₖ.

The NSP 101 comprises a network service provider access network 104 having a plurality of IPSGs 106₁ through 106_{q} (collectively IPSGs 106). As shown in FIG. 1, IPSG₁ 106₁ is provisioned for customer A 120₁, IPSG₂ 106₂ is provisioned for customers B and C 120₂ and 120ᵣ (where r illustratively equals 3), IPSG₃ 106₃ is provisioned for all three customers A, B, and C, 120₁, 120₂, and 120₃ and so on. This implies that IPSG₁ 106₁ has a routing instance for customer A and a security association with CPE_{A1} 122₁₁ and CPE_{A2} 122₁₂. The security association is used to securely tunnel packets between IPSG₁ 106₁ and the CPEs for customer A (that is, they have a pre-established secure tunnel). Similar associations hold for other IPSGs as well. In an instance where an MN 130₁ belonging to customer A roams into the region served by IPSG₁ 106₁, the MN successfully initiates a data session with IPSG₁ 106₁. Thereafter, the MN requests a VPN connection to CPE_{A1} 122₁₁. The IPSG₁ serves this request by constructing a secure tunnel between the MN 130₁ and IPSG₁ 106₁ and concatenating it with the pre-established tunnel illustratively between IPSG₁ 106₁ and CPE_{A1} 122₁₁.

Afterwards, when this MN 130₁ roams into the region served by IPSG₂ 106₂, the data session is reestablished with IPSG₂ 106₂. However, when the MN requests for the VPN service, IPSG₂ 106₂ cannot provide such VPN service, since IPSG₂ 106₂ is not provisioned for customer A. That is, IPSG₂ 106₂ is not logically connected to CPE_{A1} 122₁₁ in a secure fashion. Later on, when this MN roams into the region serviced by IPSG₃ 106₃, the data session again is reestablished with IPSG₃ 106₃. When the MN 130₁ requests for the VPN service, IPSG₃ 106₃ is able to provide the VPN session, since IPSG₃ 106₃ is provisioned for customer A.

Presently, in one solution termed “uniform-provision”, in addition to IPSG IPSG₁ 106_{1,} IPSG₃ 106_{3,} and IPSG₅ 106_{q=5}, the NSP also provisions IPSG₂ 106₂ and IPSG₄ 106₄ for customer A. The first uniform-provision solution implies that every IPSG 106 in the network is provisioned for all the customers of the NSP. This is required because of the mobile nature of the users, that is, an MN belonging to any customer can roam into the region served by any IPSG 106 and request for service. Therefore, no IPSG 106 can a priori assume that it would serve only a subset of the customers.

For example, suppose the NSP has “N” IPSGs and each can support at most “M” different provisions (recall that the number of VPN customers that can be provisioned per IPSG is limited). The total number of different provisions the NSP 100 can provide is therefore M×N. However, under this solution each IPSG 106 must be provisioned exactly the same way with every VPN customer. In practice, every VPN customer must be provisioned on every IPSG 106, and this limits the total number of supported VPN customers to merely M. Accordingly, this connectivity solution does not scale with the number of subscribed VPN customers. This, however, is not a problem for non-mobile VPN services such as remote access VPNs from home and intranet/extranet VPNs, since the NSP knows a priori, which customers are going to connect to which IPSGs (due to their geographic locations) and can statically provision the IPSGs with only the relevant subset of VPN customers.

A second solution, termed “tunnel-switching”, allows an IPSG to be provisioned for a subset of customers. For example, IPSG₂ 106₂ tunnels the MN's data session to an IPSG that is provisioned for customer A, such as IPSG₁ 106₁. The tunnel-switching solution requires each IPSG 106 to be aware of the provisions made by other IPSGs, detect the identity of the MN, and tunnel switch the session to an appropriate IPSG 106. It is noted that in certain cases, this method results in using more than one tunnel to connect an MN 130 to the appropriately provisioned IPSG 106.

The second tunnel-switching solution provisions each IPSG with a subset of VPN customers, and supports mobility through tunnel switching the MN's data sessions from the IPSG in the MN's roaming area to the appropriately provisioned IPSG. That is, the tunnel-switching solution maintains connectivity by using two or more tunnels to connect an end user to the appropriate IPSG 106.

The tunnel-switching second solution for providing MN-IPSG-CPE connectivity does not scale, since in order to handle more VPN customers, the IPSGs must support more tunnels, which in turn will reduce the number of provisions that can be made per IPSG 106. Moreover, tunnel switching among IPSGs leads to undesirable redirection of connections (commonly known as “dog-legging”) within the NSP's network, which results in an inefficient usage of network links.

### SUMMARY OF THE INVENTION

The disadvantages heretofore associated with the prior art, are overcome by the present invention of a method and apparatus for optimally provisioning connectivity in network-based mobile virtual private network (VPN) services. The method and apparatus includes provisioning each of a plurality of IP service gateways (IPSGs) to support virtual private network (VPN) tunneling between customer premise equipment of a subset of VPN customers and at least one mobile access point (MAP). The MAPs are geographically remote from the plurality of IPSGs, and each of the MAPs support VPN tunneling to mobile nodes of the subset of VPN customers.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of an exemplary prior art mobile IP network;

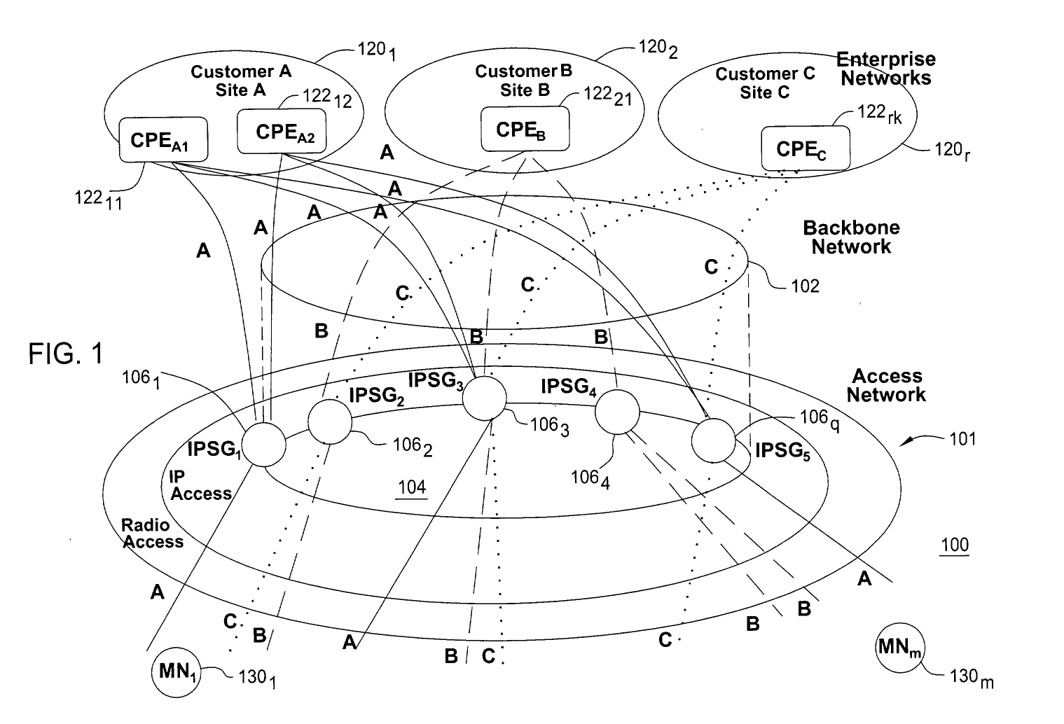

FIG. 2 depicts a high-level block diagram of an exemplary mobile IP network of the present invention;

FIG. 3 depicts a flow diagram of a method for providing virtual private network (VPN) services;

FIG. 4 depicts a schematic diagram of a first undirected graph for a single customer;

FIG. 5 depicts a flow diagram of a method suitable for selecting a subset of IP service gateways (IPSGs) to provision a single VPN customer in accordance with the method of FIG. 3; and

FIG. 6 depicts a schematic diagram of a second undirected graph for multiple customers.

To facilitate understanding, identical reference numerals have been used, where possible, to designate identical elements that are common to the figures.

### DETAILED DESCRIPTION OF THE INVENTION

The present invention provides a method and apparatus for provisioning VPN-aware devices in an hierarchical network architecture for mobile virtual private networks (VPNs). The methods discussed herein take into account the cost of links over which VPN tunnels are established, the cost of establishing a tunnel, the cost of provisioning a VPN customer on a VPN-aware device, such as an IP service gateway (IPSG), and redundancy in IPSG provisioning for fault tolerance.

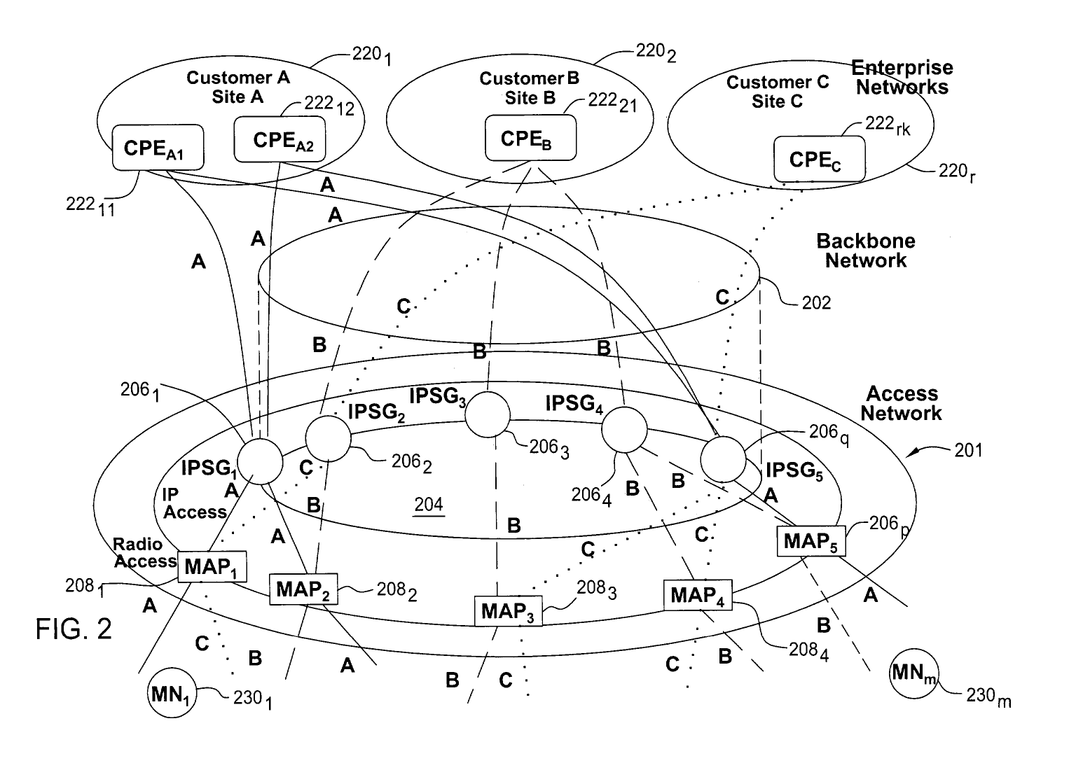

FIG. 2 depicts a high-level block diagram of an exemplary mobile IP network 200 of the present invention. The exemplary network 200 comprises a backbone network 202, such as the Internet, a plurality of enterprise networks 220₁ through 220ᵣ (collectively enterprise networks 220), a service provider 201 (e.g., network service provider (NSP)), and a plurality of mobile nodes (MN) 230₁ through 230ₘ collectively MNs 230).

The enterprise networks 220 may be an intranet/extranet network, each having at least one customer premise equipment 222. In this example, there are three VPN customers A, B, and C, each with a corresponding intranet site 220. Customer A has two CPEs 222₁₁ and 222₁₂, while customers B and C each have one CPE 222₂₁ and 222ᵣₖ. The CPE 222 typically includes a customer edge router, or Layer Two Tunneling Protocol (L2TP) network server, among other conventional customer network equipment.

The service provider 201 includes a network service provider access network 204 having a plurality of IP service gateways (IPSGs) 206₁ through 206_{q} (collectively IPSGs 206) and a plurality of wireless access devices 208 positioned at the edge of the network 204, separate and apart from the IPSGs 206. That is, in order to enable mobile data services, the NSP 201 installs the wireless access devices 208 at the edge of its network 204.

In one embodiment, the wireless access devices 208 are radio-to-packet network gateways, hereinafter termed Mobile Access Points (MAPs), which are used to connect the access devices to the data network. Accordingly, a packet data serving node (PDSN) in the CDMA 2000 architecture or a gateway GPRS support node/serving GPRS support node (GGSN/SGSN) in the UMTS architecture may serve as the MAPs. To set up a data session, a mobile end user utilizing a mobile node (MN) 230 must first connect to a MAP 208, which then routes the session towards the destination CPE through an appropriately provisioned IPSG. Thus, a network-based mobile VPN service mobile data session originates from an MN 230 to a MAP 208, and is then routed through a particular IPSG 206 to the enterprise CPE 222.

In the network-based VPN architecture of FIG. 2, the MAPs 208 are separately and hierarchically located from the IPSGs 206. In particular, a MAP 208 serves a region, and all MNs 230 within that region, regardless of customer association, connect to the MAP 208 to initiate data sessions. Each IPSG 206 is statically provisioned for only a subset of the enterprise VPN customers. The subsets per IPSG 206 are chosen so that at least one IPSG is provisioned for each customer.

In the illustrative embodiment shown in FIG. 2, IPSG₁ 206₁ and IPSG₅ 206_{q=5} are provisioned for VPN customer A 220₁, and IPSG₂ 206₂, IPSG₃ 206₃, and IPSG₄ 206₄ are provisioned for VPN customer B 220₂. Similarly, IPSG₂ 206₂ and IPSG₅ 206₅ are provisioned for VPN customer C 220ᵣ₌₃. Mobile traffic destined to customer A is directed by MAPs 208 to either IPSG₁ 206₁ or IPSG₅ 206_{5,} depending on the location of the MN 230. Each IPSG 206 only needs to support a subset of the three VPN customers 220.

An IPSG maintains the virtual routing instance and security association with each provisioned VPN customer 220. Each MAP 208 maintains a simple and fairly static list of customer-to-IPSG mappings. It is noted that the list changes only when a new customer 220 subscribes to the VPN service offered by the NSP, which is very infrequent. When an MN 230 requests a VPN connection to its respective CPE 222, the MAP 208 identifies the customer the MN belongs to, and routes and/or tunnel switches the connection to the appropriate IPSG 206 provisioned for the customer.

In particular, the MNs 230 are identified using, for example, conventional Network Access Identifiers (NAI) and/or Access Point Names (APN). A MAP extracts the NAI/APN of the MN 230 during connection setup time with the MN. The MAP can then identify the destination CPE 222 directly from the NAI/APN, if there is only one CPE 222. If there is more than one CPE 222, the MAP can determine the MN's 230 preferred CPE 222 from an Authentication, Authorization and Accounting (AAA) Server of the service provider 201.

By illustration, in an instance where an MN 230₁ belonging to customer A roams into the region served by MAP₁ 208₁, the MAP 208₁ identifies the customer the MN 230₁ belongs to, and routes and/or tunnel switches the connection to the appropriate IPSG 206 provisioned for the customer. In this example, the connection is routed to IPSG₁ 206₁. The IPSG₁ 206₁ serves this request by constructing a secure tunnel between the MN 230₁ and IPSG₁ 206₁ and concatenating it with the pre-established tunnel between IPSG₁ 206₁ and, illustratively, CPE_{A1} 222₁₁.

If the MN 230₁ roams into a region served by MAP₂ 206₂, the connection is also routed to IPSG₁ 206₁. Similarly, if the MN 230₁ roams into a region served by either MAP₃ 206₃ or MAP₄ 206₄, the connection is also routed to IPSG₁ 206₁ or IPSG₅ 206_{q=5} (connections not shown in FIG. 2).

Accordingly, one aspect of the present invention is to separate mobility from services, where a MAP 208 deals with mobility of users, while an IPSG 206 offers VPN services. This is a natural division of functions because IPSGs are designed to support services for stationary locations, while the MAPs are designed to handle mobility by providing dynamic switching and routing.

The above approach solves the scalability issues for the MN-IPSG-CPE connectivity problem. The scalability in provisioning is addressed by allocating a subset of VPN customers per IPSG, with at least one provision for every customer. In other words, this approach provisions a subset of IPSGs per customer. Compared with the existing architecture where each customer has to be provisioned on every IPSG, the hierarchical approach naturally offers improved scalability. The tunnel switching and associated dog-legging are taken care of by locating MAPs 208 separately and hierarchically with respect to IPSGs 206. In this hierarchical design, the MAPs 208 offer tunnel switching/traffic redirection functionalities. Therefore the MAPs 208 are able to separate intranet VPN traffic from internet traffic, direct VPN traffic to the appropriate IPSGs 206, and direct internet traffic to appropriate internet proxies in the NSP network 204. This value-added Internet traffic offloading service effectively saves bandwidth for the NSP 201 and its customers over the existing architecture where MAPs 208 and IPSGs 206 are collocated.

Thus, in order to establish the NSP's network connectivity, each VPN customer is mapped to a subset of IPSGs 206. One solution is to map/provision as many customers as possible on one IPSG 206, and then use a second IPSG 206 only when the current one is full. However, this technique does not utilize the resources fully. That is, it creates hot spots and degrades the overall performance of the network.

Alternatively, in an embodiment of the present invention, a subset of IPSGs 206 is chosen in an optimal fashion for each customer, so that all the IPSGs 206 are equally provisioned/utilized, while there is also room for inclusion of future customers. Determining the best set of IPSGs 206 to provision for each customer includes various factors, such as the cost of links over which VPN tunnels are established, the cost of establishing a tunnel, the cost of provisioning a VPN customer on an IPSG 206, and redundancy in IPSG provisioning for fault tolerance.

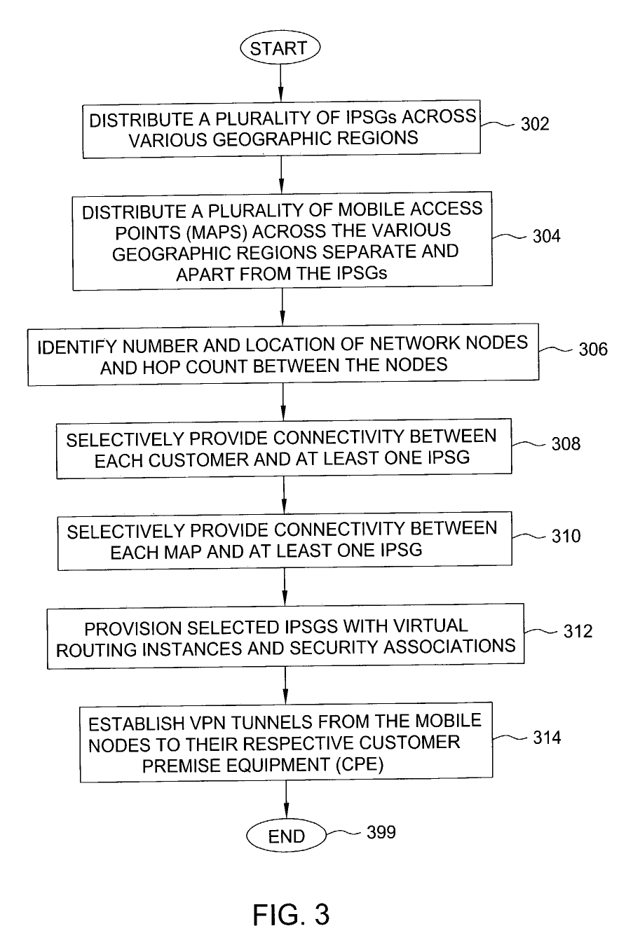

FIG. 3 depicts a flow diagram of a method 300 for providing virtual private network (VPN) services. The method 300 begins at step 301, and proceeds to step 302, a network service provider (NSP) 201 strategically distributes a plurality of IPSGs 206 across various geographic regions, such as, for example, in various parts of a large city, across a state, and/or nationwide. At step 304, the NSP 201 distributes a plurality of mobile access points (MAPs) 208 across the various geographic regions, such that the MAPs 208 are located separate and apart from the IPSGs 206.

The method 300 then proceeds to step 306 where the number and location of network nodes are identified. When the NSP 201 deploys the nodes in the network, the number and location of each IPSG 206 and MAP 208 are identified. Further, the number of customers and their respective intranets 220 and CPEs 222 are also identified. Also identified is the hop count between the nodes, such that an end-to-end hop count may be determined from a MN 230 to a CPE 222. Once the nodes and hop counts have been identified, the method 300 then proceeds to step 308.

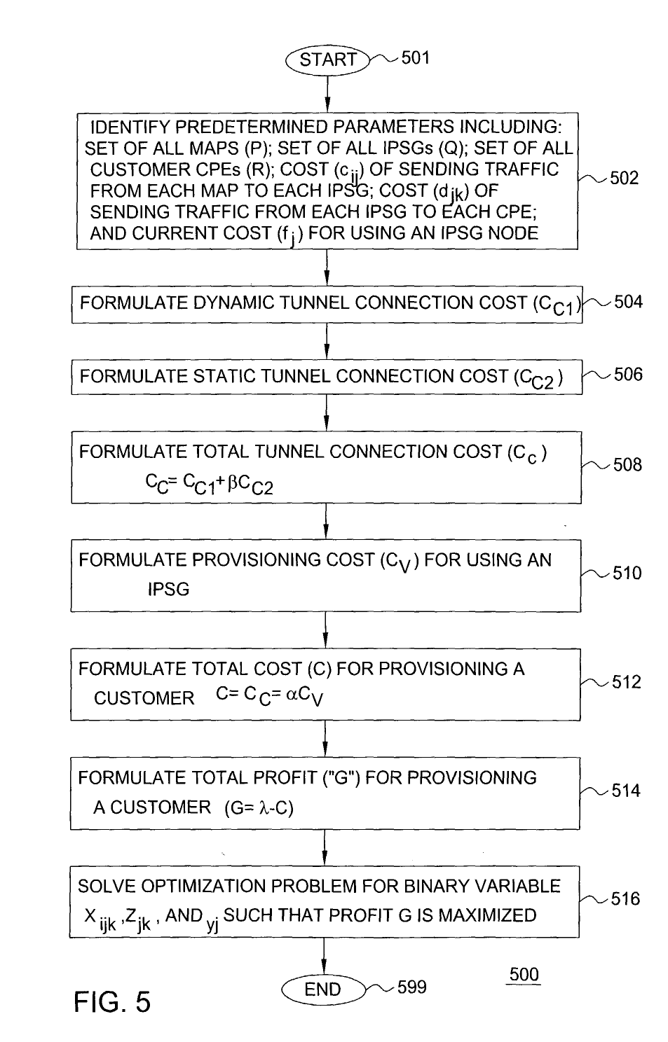

At step 308, the NSP 201 selectively provides connectivity between each customer 220 and at least one IPSG 206. That is, a determination is made to resolve particular subsets of IPSGs 206 to be provisioned for a customer. Selecting a subset of the plurality of IPSGs 206 to serve each customer 220 is based on a cost analysis algorithm, which is discussed below in further detail with respect to FIG. 5. At step 310, the NSP 201 selectively provides connectivity between each MAP 208 and at least one IPSG 206. Selection of the IPSGs 206 to support the MAPs 208 is also based on cost analysis, which is also discussed below in further detail with respect to FIG. 5. The method 300 then proceeds to step 312.

At step 312, the selected IPSGs 206 are provisioned with virtual routing instances and security associations for the customer. At step 314, the provisioned IPSGs 206 are used to establish VPN tunnels to the corresponding CPEs 222 of the customer. In particular, VPN tunnels may be established from the mobile nodes 230 to their respective CPE 122 via a MAP 208 serving the mobile node 230 and a customer specific IPSG 206. The method 300 then proceeds to step 399, where the users participate in a VPN session and the method 300 ends.

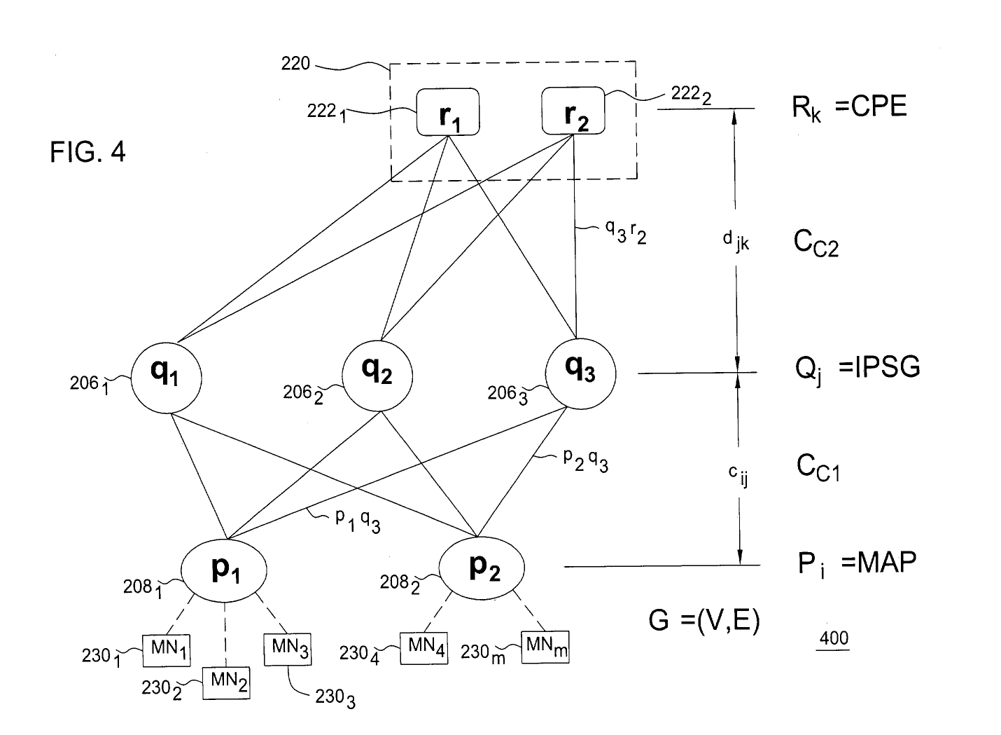

FIG. 4 depicts a schematic diagram of a first undirected graph 400 for a single customer. In particular, FIG. 4 depicts a schematic diagram of a first undirected graph 400 having a set of nodes and a set of links, and is suitable for understanding method 300 of FIG. 3. The network illustratively comprises “i” MAPs 208, “j” IPSGs 206, and “k” CPEs 222 for a given customer, respectively denoted by pᵢ, qⱼ, and rₖ. In the exemplary graph 400 of FIG. 4, the network 400 comprises two MAPs 208₁ and 208₂ denoted p₁ and p₂, three IPSGs 206₁, 206₂, and 206₃ denoted q₁, q₂, and q₃ in the network 400, and a single customer 220 having two CPEs 222₁ and 222₂ denoted r₁ and r₂for the customer. Furthermore, a plurality of mobile nodes 230₁ through 230ₘ (where m is an integer greater than 1) is illustratively shown coupled to the MAPs 208. Specifically, MN₁ 230₁ through MN₃ 230₃ have connectivity to MAP P₁ 208₁, while MN₄ 230₄ and MNₘ 230ₘ have connectivity to MAP P₂ 208₂.

It is noted that multiple VPN customers are considered in a batch and the best set of IPSGs are determined to provision for the batch that will maximize the profit. For each customer, the CPEs in the customer's intranet, and all of the IPSGs and MAPs in the NSP network are considered.

The network of IPSGs 206, MAPs 208, and the customer's CPEs 222 is modeled as an undirected graph G=(V, E), where V is the set of nodes and E is the set of links. Graph nodes in V correspond to the CPEs 222, IPSGs 206, and MAPs 208 only. Graph links in E may be categorized as a link between a MAP 208 and an IPSG 206 corresponds to the chosen path between the corresponding MAP and the IPSG, and a link between an IPSG 206 and a CPE 222 corresponds to the chosen path therebetween. A routing algorithm based on a particular routing objective computes the chosen paths. The routing objective may be the shortest path based on hop counts, or the lowest-cost path based on the cost assigned to network links, both of which can be computed by open shortest path first (OSPF). The routing objective may also be a traffic-engineered path such as an ATM VC or an MPLS Label Switched Path. In the hierarchical architecture of the present invention, traffic flows from MNs 230 to the CPEs 222 through the MAPs 208 and IPSGs 206. Therefore, only links between them are considered.

Referring to FIG. 3, at step 308, a subset of the IPSGs 206 is selected for each customer. The establishment of a VPN tunnel over a physical network link incurs a certain cost associated with the link. The cost of a link between two nodes in the graph then becomes the computed cost of the VPN tunnel between the corresponding network nodes. In practice, depending on the requirement of the VPN customer, the link cost may be the number of hops in the underlying physical network or a fraction of the bandwidth capacity of the physical links, among other link cost measuring techniques. For purposes of understanding the invention, link costs are discussed in terms of an optimal connectivity between the MAPs and the CPEs (i.e., number of hops), as opposed to computing link costs using bandwidth capacity of a physical link.

Since only one VPN tunnel is established between an IPSG and a CPE for the same customer, the cost of a link from an IPSG to a CPE is considered only once for each customer. For example, referring to FIG. 4, IPSG q₃ 206₃ may have two tunnels formed from MAPs p₁ and p₂ 208₁ and 208₂ via respective links p₁q₃ and p₂q₃. However, only one shared tunnel is utilized between the IPSG q₃ 206₃ and CPE r₂ 222₂ for those MNs connecting to CPE r₂ 222₂.

FIG. 5 depicts a flow diagram of a method 500 suitable for selecting a subset of IP service gateways (IPSGs) to provision a VPN customer in accordance with the method of FIG. 3. In particular, method 500 is suitable for providing step 308 of FIG. 3. Method 500 starts at step 501, and proceeds to steps 502, where predetermined network parameters are identified. In particular, the predetermined network parameters include a set of all MAPs (P), a set of all IPSGs (Q), a set of all customer CPE (R), the cost (cᵢⱼ) of sending traffic from each MAP 208 to each IPSG 206, the cost (dⱼₖ) of sending traffic from each IPSG 206 to each CPE 222, and the current cost (fⱼ) for using an IPSG node (j) 206.

At step 504, dynamic tunnel connection costs (C_{C1}) are formulated as between the MAPs (pᵢ of FIG. 4) and IPSGs (qᵢ of FIG. 4). Further, at step 506, static tunnel connection costs (C_{C2}) are formulated as between the IPSGs (qᵢ of FIG. 4) and the CPEs (rₖ of FIG. 4).

In particular, connection cost may be considered in terms of VPN tunnels. For every session from a user of a customer to a CPE, a VPN tunnel is established from a MAP to an IPSG. The VPN tunnel from a MAP to an IPSG is referred to as a “dynamic tunnel”, since the VPN tunnel is typically established by a user “on-the-fly”. However, the traffic from the IPSG to the CPE will be aggregated over one tunnel, termed a “static tunnel”. In this instance, the cost from an IPSG to a CPE is included in the overall connection cost only once. For purposes of clarity and understanding the invention, optimization and selection of the IPSGs is formulated for a single customer, and then generalized for multiple customers.

A service providers profits may be maximized by selecting optimal IPSGs to provision a given VPN customer. It is noted that profit (G=γ R−C) is the difference between weighted revenue (γ R) and cost (C), where revenue (R) for a customer is a fixed value if the customer can be provisioned and γ is the relative weight on revenue compared to cost.

The cost has several components, and as discussed above, determining the best set of IPSGs to provision each customer includes factoring in the cost of links over which VPN tunnels are established, the cost of establishing a tunnel, the cost of provisioning a VPN customer on an IPSG, and redundancy in IPSG provisioning for fault tolerance. In other words, for every MAP i in P and every CPE k in R, an IPSG j in Q is selected to establish a unique dynamic tunnel between i and j, and a shared static tunnel between j and k, such that the profit is maximized.

Referring to FIG. 4, P is the set of all MAPs 208, Q is the set of all IPSGs 206, and R is the set of all CPEs 222 for a customer. The binary variable xᵢⱼₖε {0,1} denotes whether a dynamic tunnel between node i ε P and node j ε Q is used for the traffic from MAP i to CPE k 68 R. The binary variable zⱼₖ ε {0,1} denotes whether a shared static tunnel from IPSG j to CPE k is established. Here the cost of sending traffic from node i to node j is cᵢⱼ, and the cost of sending traffic from node j to node k is dⱼₖ.

For a single customer, the dynamic tunnel connection cost (which is illustratively the hop count cost between the MAPs and the IPSGs) is

$${C}_{C1} = {\sum }_{i ∈ P , j ∈ Q , k ∈ R}^{} {c}_{ij} {x}_{ijk} .$$

Similarly, the static tunnel connection cost (which is illustratively the hop count cost between the IPSGs and the CPEs) is

$${C}_{C2} = {\sum }_{j ∈ Q , k ∈ R}^{} {d}_{ij} {z}_{jk} .$$

At step 508, the total tunnel connection cost (C_{C}) is formulated. The total connection cost is the sum of the dynamic tunnel connection cost and the static tunnel connection cost C_{C}=C_{C1}+βC_{C2}, where β is the relative weight on the static tunnel connection cost. Factors influencing the relative weight β on the static tunnel connection cost include the cost of transporting data over core network over the cost over access network.

At step 510, the current cost C_{V} of provisioning a IPSG node (j) is formulated. The binary variable yⱼ ε {0,1} is 1 if IPSG j is provisioned for the customer to send traffic to at least one of its CPEs, and it is 0 otherwise. The parameter fⱼ is illustratively used as the current cost of using IPSG node j. For a given customer, at most one provision is considered at any IPSG. Therefore fⱼ has a fixed value when only one customer is considered at a time, and the provisioning cost is

$${C}_{V} = {\sum }_{j ∈ Q}^{} {f}_{j} {y}_{j} .$$

At step 512, the total cost for the customer is formulated. In particular, the total cost is C=C_{C}+αC_{V} where α is the relative weight on the provision cost. Factors influencing the relative weight α on the provision cost include the importance of provision costs over connection costs for the network service provider.

At step 514, the profit is formulated. In particular, the profit is G=γ R−C. For simplicity, revenue R=1. Therefore, the profit “G” for provisioning the customer is G=γ−C, where γ is the relative weight on revenue compared to total cost. The weighting factor γ essentially allows the network service provider to adjust price based on the total cost for the customer.

At step 516, given parameters cᵢⱼ, dⱼₖ fⱼ, α, β and γ, binary variables xᵢⱼₖ, zⱼₖ and yⱼ are determined as the solution to the optimization problem formulation expressed as:

max G=γ−C (1)

where

C=(C_{C1}+βC_{C2})+αC_{V} (2)

$$C = ( {\sum }_{i ∈ P , j ∈ Q , k ∈ R}^{} {c}_{ij} {x}_{ijk} + β {\sum }_{j ∈ Q , k ∈ R}^{} {d}_{jk} {z}_{jk} ) + α {\sum }_{j ∈ Q}^{} {f}_{j} {y}_{j} \qquad ( 3 )$$

xᵢⱼₖ ε {0,1}, ∀i ε P,∀j ε Q,∀k ε R (4)

zⱼₖ ε {0,1},∀j ε Q,∀k ε R (5)

yᵢ ε {0,1},∀j ε Q (6)

$${\sum }_{j ∈ Q}^{} {x}_{ijk} = 1 , ∀ i ∈ P , ∀ k ∈ R \qquad ( 7 )$$

xᵢⱼₖ≦zⱼₖ,∀i ε P,∀j ε Q,∀k ε R (8)

zⱼₖ≦yⱼ,∀j ε Q,∀k ε R (9)

It is noted that equation (3) is an expanded version of equation (2). It is further noted that equation (7) specifies that exactly one link out of a MAP is chosen to go to one CPE, thereby implying that traffic from a MAP to a CPE is sent to only one IPSG. Equation (8) specifies a condition that only one tunnel is established between an IPSG and a CPE, even if traffic from multiple MAPs are going through the IPSG to reach the CPE. That is:

$${z}_{jk} = 1 , if {\sum }_{i ∈ P}^{} {x}_{ijk} > 0 , ∀ j ∈ Q , ∀ k ∈ R \qquad ( 10 )$$

zⱼₖ=0 otherwise. (11)

Equations (10) and (11) are equivalent to condition (8), since zⱼₖ is in the objective function G, and when xᵢⱼₖ=0, ∀i εP, to maximize G, zⱼₖ=0 must be chosen.

The condition expressed in equation (9) specifies that even if an IPSG is provisioned to send traffic to more than one CPE, for the purpose of computing provision cost, it should be considered as only one provision. That is,

$${y}_{j} = 1 , if {\sum }_{k ∈ R}^{} {z}_{jk} > 0 , ∀ j ∈ Q \qquad ( 12 )$$

yⱼ=0 otherwise. (13)

Equations (12) and (13) are equivalent to the condition expressed in equation (9), since yⱼ is in the objective function G, and when zⱼₖ=0,∀k εR, to maximize G, yⱼ=0 must be chosen. At step 518, the method 500 ends.

Once the provisioning costs are determined, the profit G for provisioning a customer with a particular subset of IPSGs may be computed. Specifically, profit equals revenues less provisioning costs G=λ−C. In other words, the connectivity between the mobile node 230 and CPE 222 may be optimized, since the sum of the costs between the nodes (i.e., hop count) and the cost of provisioning IPSGs is minimized by provisioning a particular subset of IPSG 206 for a customer 220.

In the multiple customer case, the sum of the profit for each customer is maximized, where the profit for each customer is calculated exactly the same way as in the single customer case discussed above. All MAPs 208 and IPSGs 206 in the network are shared among all customers. However, each customer has its distinct set of CPEs.

In the single customer case, the provision cost fⱼ at each IPSG j has a fixed value, and an IPSG that has reached its provision capacity is not considered, which is equivalent to setting fⱼ=∞. When multiple customers are considered, fⱼ is assigned a fixed value for all customers provisioned on IPSG j, however, because multiple customers can be provisioned at each IPSG, care must be taken to ensure that the number of customers provisioned does not exceed the provision capacity of each IPSG. Moreover, when multiple customers are considered at the same time, not every customer should be provisioned in the network. Priorities should be given to customers providing maximum profit. There are two cases where a customer is rejected. One case is when there is no more provision capacity left on any IPSG in the network, the other case is when provisioning this customer results in negative profit, meaning a loss. Essentially to maximize the total profit a subset of the customers are provisioned. The rest of the customers are rejected because either the provision capacity is reached or they produce a loss instead of profit.

The optimization problem for multiple VPN customers can be described as follows. Let T be the set of VPN customers to consider and |T|=L. Let P be the set of all MAPs, Q be the set of all IPSGs, and R be the set of all CPEs for all customers where R={R₁,R₂, . . . ,Rₗ, . . . ,R_{L}} and Rₗ is the set of CPEs for customer l ε T. Let w^{l} be the binary variable specifying if customer l should be provisioned in the network. For each customer l provisioned, every node i in P and every node k in Rₗ, choose an IPSG node j in Q, to establish a unique tunnel between i and j, and a shared tunnel between j and k, such that the total profit for all customers is maximized. Needless to say, for a customer not provisioned, the cost is 0.

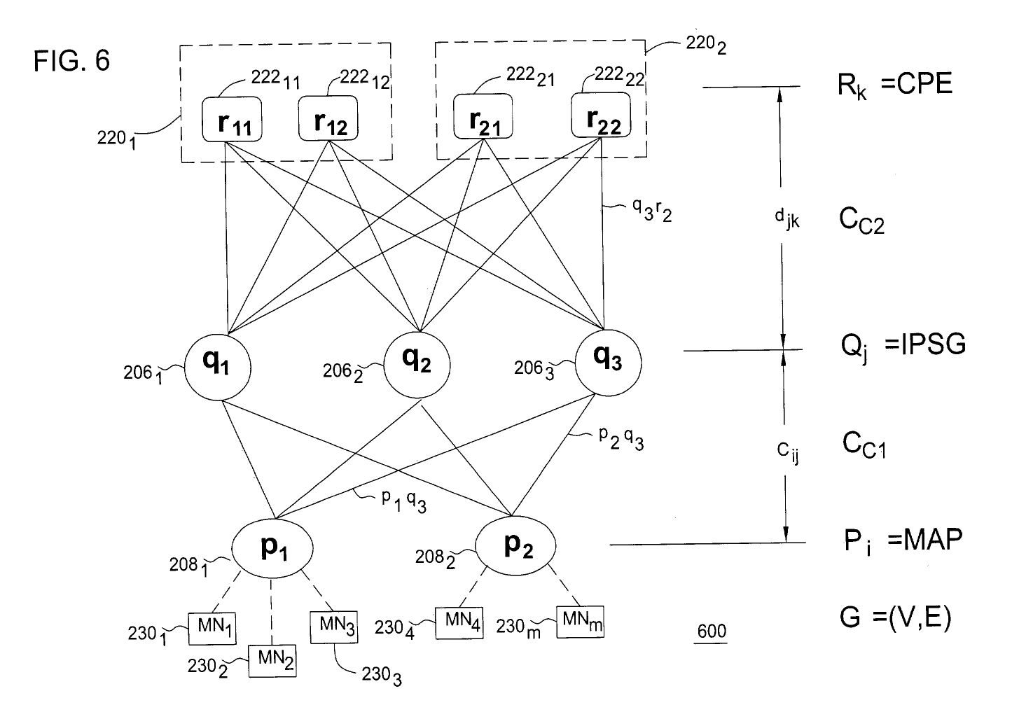

FIG. 6 depicts a schematic diagram of a second undirected graph 600 for multiple customers. FIG. 6 is the same as FIG. 4, except that two customers 220 are illustratively shown, each having two CPEs 222. In particular, the network 600 illustratively comprises “i” MAPs 208, “j” IPSGs 206, and “k” CPEs 222 for a given customer, respectively denoted by pᵢ, qⱼ, and rₖ. In the exemplary graph 600 of FIG. 6, the network 600 comprises two MAPs 208₁ and 208₂ denoted p₁ and p₂, three IPSGs 206₁, 206₂, and 206₃ denoted q₁, q₂, and q₃ in the network 400, and a two customers 220₁ and 220₂. Each customer illustratively has two CPEs, such as CPE 222₁₁ and 222₁₂ denoted r₁₁ and r₁₂ for a first customer 220₁, and CPE 222₂₁ and 222₂₂ denoted r₂₁ and r₂₂ for a second customer 220₂. Furthermore, a plurality of mobile nodes 230ₘ is illustratively shown coupled to the MAPs 208. Specifically, MN₁ 230₁ through MN₃ 230₃ have connectivity to MAP P₁ 208₁, while MN₄ 230₄ and MNₘ 230ₘ have connectivity to MAP P₂ 208₂.

For customer l ε T, we denote by the binary variable xᵢⱼₖ^{l} ε {0,1} whether a tunnel between node i ε P and node j ε Q is used for the traffic from MAP i to CPE k ε Rₗ. We use binary variable zⱼₖ^{l} ε {0,1} to denote whether a shared tunnel from IPSG j to CPE k is established. The cost of sending traffic from node i to node j is cᵢⱼ. Notice that the cost is the same for all customers, and therefore index l is not needed. The cost of sending traffic from node j to node k is dⱼₖ^{l}.

The binary variable yⱼ^{l} ε {0,1} is 1 if IPSG j is provisioned for customer l to send traffic to at least one of its CPEs, and it is 0 otherwise. We use parameter P_{cap} as the maximum number of customers that can be provisioned on each IPSG, and parameter fⱼ as the cost for customer l to use node j. As long as the provision capacity of IPSG j has not been reached, the provision cost for each customer is the same, and therefore index l is not needed.

For a single customer l ε T under consideration, the dynamic tunnel connection cost (which is the cost from MAPs to IPSGs) is

$${C}_{C1}^{l} = {\sum }_{i ∈ P , j ∈ Q , k ∈ {R}_{l}}^{} \cdot {c}_{ij} {x}_{ijk}^{l} .$$

The shared static tunnel connection cost (which is the cost from IPSGs to MAPs) is

$${C}_{C2}^{l} = {\sum }_{j ∈ Q , k ∈ {R}_{l}}^{} \cdot {d}_{jk}^{l} {z}_{ijk}^{l} .$$

The total connection cost is therefore, C_{C}^{l}=C_{C1}^{l}+βC_{C2}^{l}, where β is the relative weight on static tunnel connection cost. The provisioning cost for customer l is

$${C}_{V}^{l} = {\sum }_{j ∈ Q}^{} {f}_{j} {y}_{j}^{l} .$$

Thus, the total cost for customer l is C^{l}=C_{C}^{l}+αC_{V}^{l} where α is the relative weight on the provision cost. The revenue for each customer provisioned is assumed to be the same. Accordingly, both the revenue and cost are zero for each customer not provisioned. The profit is therefore G^{l}=γw^{l}−C^{l} where γ is the relative weight on revenue compared to cost. The optimization problem formulation can then be specified as

$$max G = {\sum }_{l ∈ T} {G}^{1} \qquad ( 14 )$$

where

G^{l}=γw^{l}−C^{l}, ∀l ε T (15)

C^{l}=(C_{C1}^{l}+βC_{C2}^{l})+αC_{V}^{l} (16)

$${C}^{1} = ( {\sum }_{i ∈ P , j ∈ Q , k ∈ {R}_{l}} {c}_{ij} {x}_{ijk}^{l} + β {\sum }_{j ∈ Q , k ∈ {R}_{l}} {d}_{jk}^{l} {z}_{jk}^{l} ) + α {\sum }_{j ∈ Q} {f}_{j} {y}_{j}^{l} \qquad ( 17 )$$

w^{l} ε {0,1},∀l ε T (18)

xᵢⱼₖ^{l} ε {0,1}∀l ε T, ε i ε P,∀j ε Q,∀k ε Rₗ (19)

zⱼₖ^{l} ε {0,1}∀l ε T,∀j ε Q,∀k ε Rₗ (20)

yⱼ^{l} ε {0,1}∀l ε T,∀j ε Q (21)

$${\sum }_{j ∈ Q} {x}_{ijk}^{l} = {w}^{l} , ∀ l ∈ T , ∀ i ∈ P , ∀ k ∈ {R}_{l} \qquad ( 22 )$$

xᵢⱼₖ^{l}≦zⱼₖ^{l},∀l ε T,∀i ε P,∀j ε Q,∀k ε Rₗ (23)

zⱼₖ^{l}≦yⱼ^{l},∀l ε T,∀j ε Q,∀k ε Rₗ (24)

$${\sum }_{l ∈ T} {y}_{j}^{l} \leq {P}_{cap} , ∀ j ∈ Q \qquad ( 25 )$$

It is noted that equation (17) is an expanded version of equation (16). Compared with the formulation for a single customer, condition (25) is added to specify that the total number of provisions on each IPSG j cannot exceed its capacity P_{cap}. Moreover, a new binary variable w^{l} is introduced to specify if a customer is provisioned, and Condition (22) is modified to specify that only when a customer is provisioned, exactly one link out of a MAP is chosen to go to one CPE for this customer, otherwise no link out of any MAP is chosen and no IPSG is provisioned.

In order to solve the integer-programming problem discussed above, connection costs cᵢⱼ, dⱼₖ and provision cost fⱼ need to be assigned appropriate values. The cost computation can be adapted to fit the NSP's design objectives. This makes the above formulation quite general and can be used for different scenarios in addition to guaranteeing connectivity for VPN customers.

Connection cost is a function of the parameters that the NSP wants to control. A NSP 204 may need to satisfy a special requirement from a VPN customer 220, such that the users of this customer are not switched to a remote lightly loaded IPSG 206, even if that reduces the total cost for the NSP 204. For example, an MN 230 on the east coast trying to access corporate intranet on the east coast should not be switched to an IPSG on the west coast even if the total cost is minimized with this solution. To take the constraint into account, we restrict the number of hops allowed from a MAP to a CPE and the link cost of the graph is modified as:

cᵢⱼ=∞, if cᵢⱼ>L1ₘₐₓ, ∀i ε P, and ∀jε Q (26)

dⱼₖ=∞, if dⱼₖ^{l}>L2ₘₐₓ, ∀j ε Q, ∀k ε R, and ∀l ε T (27)

where L1ₘₐₓ and L2ₘₐₓ are the maximum number of hops allowed for the tunnel between a MAP 208 and a IPSG 206 and the tunnel between the IPSG 208 and a CPE 222, respectively.

When a single customer is considered at a time, the provision cost may be optionally set to reflect the existing number of provisions at each IPSG. For example, the provisioning cost fⱼ=capⱼ/availⱼ, where capⱼ is the capacity of IPSG j and avaljᵢ is the number of available provisions left. This cost assignment will result in even distribution of the number of provisions per IPSG across all IPSGs 206.

However, when multiple customers are considered at the same time, the provision cost for different customers has to be the same to be a valid input to the integer-programming program. Without loss of generality, we set fⱼ=1 for IPSG j for all customers.

The cost computation phase accounts for customer specific requirements. After the cost computation phase, conventional integer programming packages (e.g., LPSOLVE and CPLEX) may be used to solve the IPSG selection problem.

Fault tolerance may be provided to ensure that if a tunneling IPSG fails, at least second IPSG is available to provide redundancy. In one embodiment, a minimum bound is placed on the replication. In order to provide fault tolerance, for every customer, each traffic session from a MAP to a CPE should have the option of going through N>1 IPSGs. In case N−1 IPSGs fail, traffic sessions can still be established using the functioning IPSG. The only modification to the formulation provided in condition (22) without fault tolerance consideration, is to substitute Condition (22) with

$${\sum }_{j ∈ Q} {x}_{ijk}^{l} = {Nw}^{l} , ∀ l ∈ T , ∀ i ∈ P , ∀ k ∈ {R}_{l} \qquad ( 28 )$$

Condition (28) specifies for each customer l ε T that is provisioned, there must be N connections established between a MAP 208 and a CPE 222 each going through a separate IPSG 206. Because each pair of MAP and CPE requires the use of a set of N IPSGs, and these IPSG sets can overlap, therefore the total number of IPSGs used for customer l is greater than or equal to N. In other words, this formulation specifies the minimum number of IPSGs provisioned for each customer.

In a second embodiment, an exact bound is placed on the replication. Another way to consider fault tolerance is to require that each customer can only use exactly N IPSGs for all its connections. This would require one more condition to be added to the formulation as follows:

$${\sum }_{j ∈ Q} {y}_{j}^{l} = {Nw}^{l} , ∀ l ∈ T \qquad ( 29 )$$

Condition (29) specifies exactly N IPSG nodes can be used for all the connections for a provisioned customer l.

Accordingly, a hierarchical architecture using two network elements, namely the MAPs 208 and IPSGs 206, has been illustratively shown to provide mobile VPN services. In order to optimally use the network elements, several costs have been identified, which influence the designing of the network. In particular, the IPSGs are provisioned for mobile VPN customers in order to minimize the total connection cost of links over which VPN tunnels are established, as well as the cost of provisioning IPSGs for each customer.

Although various embodiments that incorporate the teachings of the present invention have been shown and described in detail herein, those skilled in the art can readily devise many other varied embodiments that still incorporate these teachings.

What is claimed is:

1. A method, comprising:
provisioning each of a plurality of IP service gateways (IPSGs) to support virtual private network (VPN) tunneling between customer premise equipment (CPE) of a subset of VPN customers and at least one mobile access point (MAP), each of said MAPs being geographically remote from said plurality of IPSGs and supporting VPN tunneling to mobile nodes of said subset of VPN customers.

2. The method of claim 1, wherein for priority VPN customers, at least one IPSG is used to support VPN tunneling between respective customer premise equipment and said at least one MAP.

3. The method of claim 2, wherein for each customer that is provisioned, N connections are established between a MAP and a CPE via separate IPSGs, where N is an integer greater than one.

4. The method of claim 3, wherein the IPSGs used for fault tolerance is greater than or equal to N.

5. The method of claim 2, wherein exactly N IPSGs are utilized for all connections of a provisioned customer, where N is an integer greater than one.

6. The method of claim 1, further comprising:
for each customer, selecting a subset of IPSGs to maximize total profit resulting from provisioning said customers on the selected IPSGs.

7. The method of claim 6, wherein said total profit from all the customers comprises the sum of profits from each customer, where for each customer profit (G) equals weighted revenue (γ R) less cost (C) (G=γ R−C).

8. The method of claim 7, wherein said weighted revenue (γ R) comprises revenue (R) and a relative weight factor γ on revenue compared to cost, where γ allows a network service provider to adjust price based on cost of the customer.

9. The method of claim 7, wherein said cost per customer comprises a total tunnel connection cost (C_{C}) from said MAP to said CPE, and a current cost (C_{V}) of provisioning an IPSG node.

10. The method of claim 9, wherein said total tunnel connection cost comprises a dynamic tunnel connection cost between said MAP and said provisioned IPSG, and a static tunnel connection cost between said provisioned IPSG and said CPE.

11. The method of claim 9, wherein only a single link of a MAP is selected to go to one CPE, such that traffic from said MAP to said CPE is sent to only one IPSG.

12. The method of claim 9, wherein only a single tunnel is established between said provisioned IPSG and said CPE, even during instances where traffic from multiple MAPs are going through said provisioned IPSG to reach said CPE.

13. The method of claim 9, wherein in an instance said provisioned IPSG sends traffic to more than one CPE, said provision cost is counted only once.

14. The method of claim 9, wherein said cost per customer is determined by
$$C = ( {\sum }_{i ∈ P , j ∈ Q , k ∈ R} {c}_{ij} {x}_{ijk} + β {\sum }_{j ∈ Q , k ∈ R} {d}_{jk} {z}_{jk} ) + α {\sum }_{j ∈ Q} {f}_{j} {y}_{j} ,$$
where cᵢⱼ is a cost of sending traffic from a MAP node i to an IPSG node j, xᵢⱼₖ is a binary variable denoting whether a dynamic tunnel from MAP i to IPSG j is established for traffic from MAP i to CPE node k, dⱼₖ is a cost of sending traffic from said IPSG node j to said CPE node k, zⱼₖ is a binary variable denoting whether a shared static tunnel from IPSG node j to CPE node k is established, β represents a weighing factor with respect to said shared static tunnel, fⱼ is a provisioning cost using said IPSG node, yⱼ is a binary variable denoting whether said IPSG j is provisioned for a provisioned customer to send traffic to at least one of its CPEs, and α is a weighing factor for provision cost over total connection cost.

15. The method of claim 9, wherein said tunnel connection cost comprises hop counts between nodes.

16. The method of claim 15, wherein said hop count between a MAP to an IPSG is restricted to a first predetermined value.

17. The method of claim 16, wherein said hop count between said IPSG and a CPE is restricted to a second predetermined value.

18. The method of claim 1, further comprising:
periodically determining a profit for provisioning a VPN customer using each of N IPSGs, where N is an integer greater than one; and
reprovisioning said VPN customers using the IPSGs exhibiting greatest profit.

19. A virtual private network (VPN) system architecture, comprising:
a plurality of IP service gateways (IPSGs), each of said IPSGs supporting VPN tunneling between customer premise equipment (CPE) of a subset of VPN customers and at least one mobile access point (MAP), wherein each of said MAPs is geographically remote from said IPSGs; and
said at least one MAP supporting VPN tunneling between corresponding IPSGs and mobile nodes (MNs) of said subset of VPN customers.

20. The system architecture of claim 19, wherein said MAPs provide dynamic switching and routing of data connections, while said IPSGs provide VPN services.

21. A computer readable medium for storing instructions that, when executed by a processor, perform a method for optimally provisioning connectivity for network-based mobile virtual private network (VPN) services, comprising
provisioning each of a plurality of IP service gateways (IPSGs) to support VPN tunneling between customer premise equipment of a subset of VPN customers and at least one mobile access point (MAP), each MAP being geographically remote from said plurality of IPSGs and supporting VPN tunneling to mobile nodes of said subset of VPN customers.
